(19) United States
(12) Patent Application Publication
(10) Pub. No.: US 2025/0139412 A1
(43) Pub. Date: May 1, 2025

(54) DATA GENERATION FOR ARTIFICIAL INTELLIGENCE MODEL TRAINING

(71) Applicant: Capital One Services, LLC, McLean, VA (US)

(72) Inventors: Trijeet SETHI, McKinney, TX (US); Enwang ZHOU, Frisco, TX (US); Muralikumar VENKATASUBRAMANIAM, Plano, TX (US)

(21) Appl. No.: 18/498,738

(22) Filed: Oct. 31, 2023

(51) Int. Cl. G06N 3/0455

(52) U.S. Cl. CPC G06N 3/0455

(57) ABSTRACT

In some implementations, a device may receive input data for machine learning model training. The device may generate, based on the input data, artificial data using one or more machine learning models operating on one or more servers, wherein the one or more machine learning models includes a generative artificial intelligence model configured to generate the artificial data such that the artificial data shares a set of common characteristics with the input data. The device may train, using the artificial data and metadata associated with the artificial data, a particular machine learning model. The device may transmit an output associated with the particular machine learning model.

### BACKGROUND

A computing device may train an artificial intelligence model using a data set. However, some data may be subject to restrictions on use by computing systems. For example, medical data, location data, personal information, financial data, intellectual property, or other types of data may have usage restrictions. Examples of legal compliance restrictions that data may be subject to include General Data Protection Regulation (GDPR) compliance, Health Insurance Portability and Accountability Act (HIPAA) compliance, California Consumer Privacy Act (CCPA) compliance, or Sarbanes-Oxley Act compliance, among other examples. Further, some entities may subject data to entity-specific restrictions. For example, a financial services entity may establish privacy standards for usage of consumer financial data. Similarly, a research entity may establish privacy standards for usage of intellectual property, such as trade secret data or other intellectual property.

### SUMMARY

Some implementations described herein relate to a system for synthetic data generation. The system may include one or more memories and one or more processors communicatively coupled to the one or more memories. The one or more processors may be configured to receive a first data set, wherein the first data set is subject to a usage restriction. The one or more processors may be configured to generate a first set of statistical metrics associated with the first data set based on values of the first data set. The one or more processors may be configured to generate a second set of statistical metrics associated with the first set of statistical metrics and the values of the first data set, wherein the first set of statistical metrics and the second set of statistical metrics comprise a second data set that is not subject to the usage restriction, wherein the second set of statistical metrics represents a set of correlations between the values of the first data set and the first set of statistical metrics. The one or more processors may be configured to generate a set of embeddings with artificial noise based on the second data set. The one or more processors may be configured to output information associated with the set of embeddings.

Some implementations described herein relate to a method of generating testing data using a generative artificial intelligence model. The method may include receiving, by a device, input data for machine learning model training. The method may include generating, by the device and based on the input data, artificial data using one or more machine learning models operating on one or more servers, wherein the one or more machine learning models includes a generative artificial intelligence model configured to generate the artificial data such that the artificial data shares a set of common characteristics with the input data. The method may include training, by the device and using the artificial data and metadata associated with the artificial data, a particular machine learning model. The method may include transmitting, by the device, an output associated with the particular machine learning model.

Some implementations described herein relate to a non-transitory computer-readable medium that stores a set of instructions. The set of instructions, when executed by one or more processors of a system, may cause the system to receive a first data set, wherein the first data set is subject to a usage restriction. The set of instructions, when executed by one or more processors of the system, may cause the system to generate a first set of statistical metrics associated with the first data set based on values of the first data set. The set of instructions, when executed by one or more processors of the system, may cause the system to generate a second set of statistical metrics associated with the first set of statistical metrics and the values of the first data set, wherein the first set of statistical metrics and the second set of statistical metrics comprise a second data set that is not subject to the usage restriction, and wherein the second data set includes artificial data and metadata for the artificial data, wherein the second set of statistical metrics represents a set of correlations between the values of the first data set and the first set of statistical metrics. The set of instructions, when executed by one or more processors of the system, may cause the system to generate a set of embeddings with artificial noise based on the second data set. The set of instructions, when executed by one or more processors of the system, may cause the system to output information associated with the set of embeddings.

### BRIEF DESCRIPTION OF THE DRAWINGS

FIGS. 1A-1C are diagrams of an example associated with data generation for artificial intelligence model training, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with data generation for artificial intelligence model training, in accordance with some embodiments of the present disclosure.

FIG. 4 is a flowchart of an example process associated with data generation for artificial intelligence model training, in accordance with some embodiments of the present disclosure.

### DETAILED DESCRIPTION

The following detailed description of example implementations refers to the accompanying drawings. The same reference numbers in different drawings may identify the same or similar elements.

Entities may use software components to manipulate data sets and generate outputs associated with the data sets. For example, a chemical processing system may use hundreds, thousands, or millions of sensor measurements as inputs to an artificial intelligence model that may predict one or more control parameters for controlling production of a manufacturing output. Similarly, an entity may use an artificial intelligence model to analyze health data regarding a set of patients to derive information regarding whether a particular intervention (e.g., medicine or treatment) is effective. In a fraud detection context, a transaction processing system may use data regarding previous transactions to determine whether a particular transaction is fraudulent and to determine whether to process or reject the particular transaction.

However, some data sets involve private or otherwise protected data. For example, some data sets are protected under personal healthcare data restrictions, data privacy restrictions, financial privacy restrictions, intellectual property restrictions, or other restrictions for preventing unwanted disclosure of personal information. In such cases, deploying a software component, such as an artificial intelligence model, that is trained on or that uses a data set, which includes protected data, may risk inadvertent disclosure of the protected data. Accordingly, it may be desirable to enable deployment of software components that use data sets, without including protected data in the data sets. However, omitting protected data from the data sets may result in non-representative data sets, which may reduce an accuracy of determinations using the data sets. Similarly, other data sets may be entirely protected data, thereby eliminating a possibility of using such data sets without exposing the protected data. Furthermore, some data sets with protected data may have limited amounts of data entries therein, as a result of the protection of the data set, which may prevent usage of the data sets for use cases that rely on large data sets.

Some implementations described herein enable generation of synthetic data sets for testing or deployment of software components. For example, a system may generate a synthetic data set using a set of statistical metrics of an original, protected data set, as described in more detail herein. In this case, the synthetic data set may be usable for testing or training of software components, such as artificial intelligence models, without exposing the underlying, original, protected data set. Additionally, or alternatively, the system may use a generative adversarial network to generate the synthetic data set such that the synthetic data set can have an arbitrary size. In this way, the synthetic data set can be generated with more data entries than the underlying, protected data set, thereby enabling improved training or deployment of software components. Some implementations described herein provide an architecture of hardware components and software components to efficiently generate arbitrary, artificial data sets, such as synthetic data sets. For example, the architecture may include a plurality of synthetic resource groups with persistent storage arrays, storage interfaces, and controllers linked by a local area network (LAN) and/or a storage area network (SAN), as described in more detail herein. In this case, the architecture enables redundant storing, updating, and disseminating (e.g., transmitting) generated data, thereby improving synthetic data generation and software component training or deployment performance.

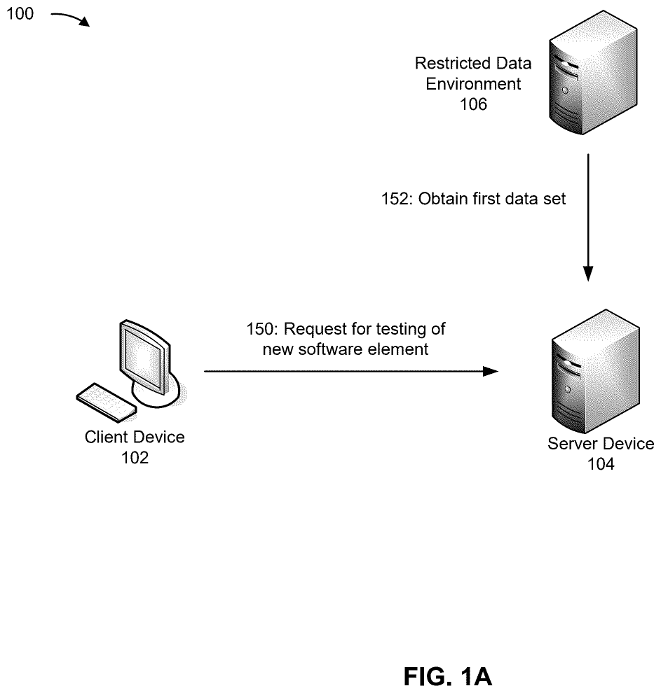

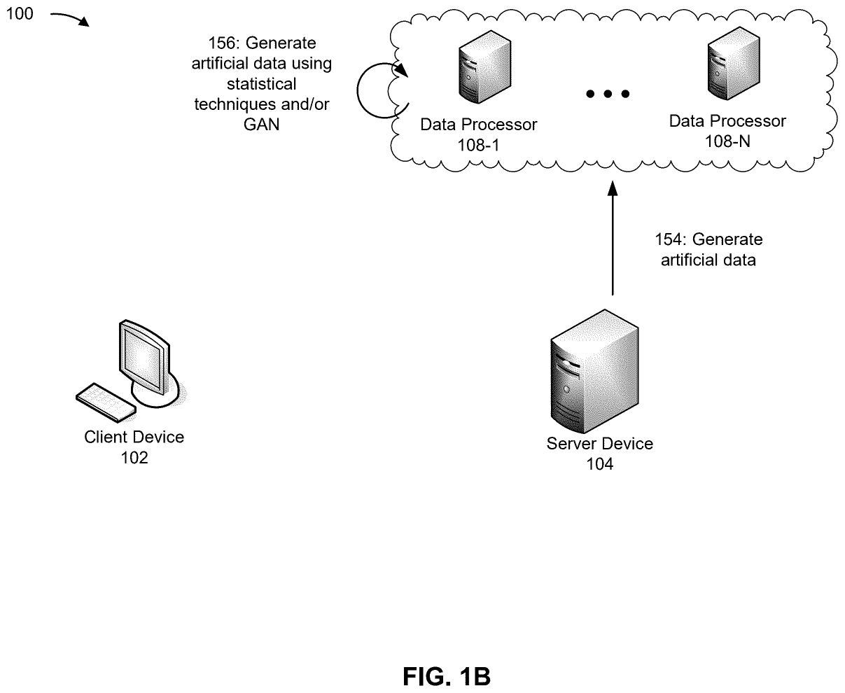

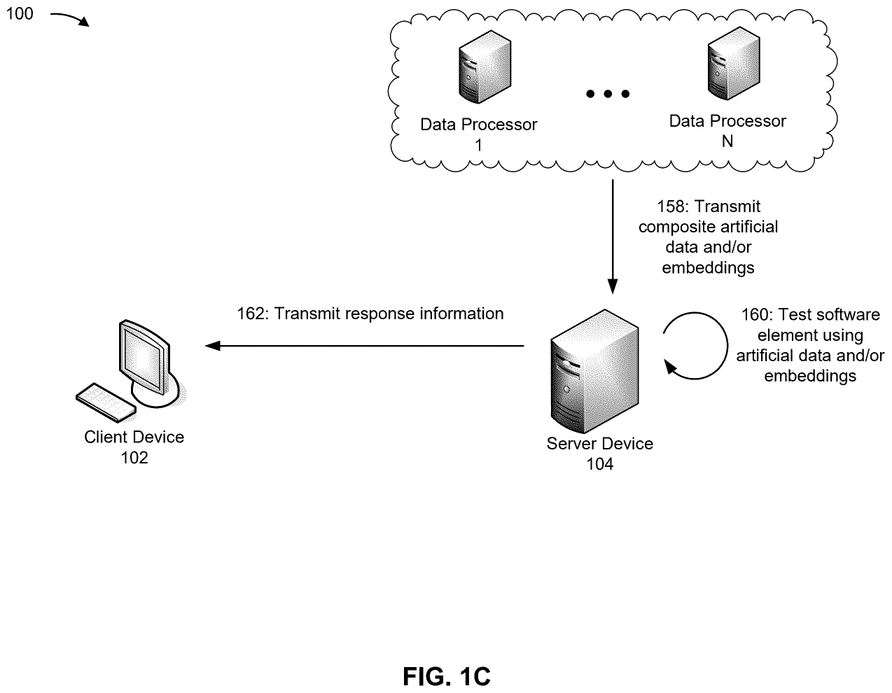

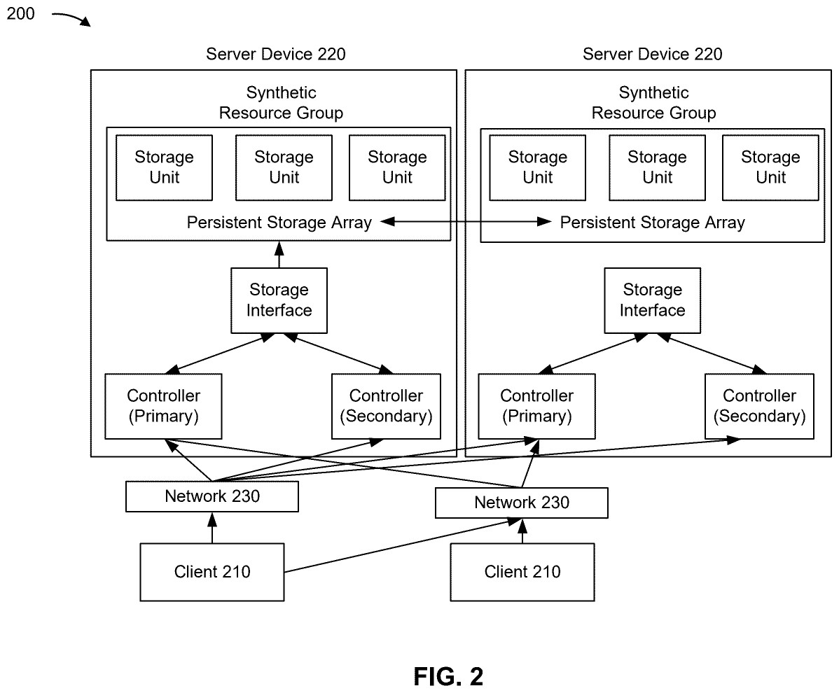

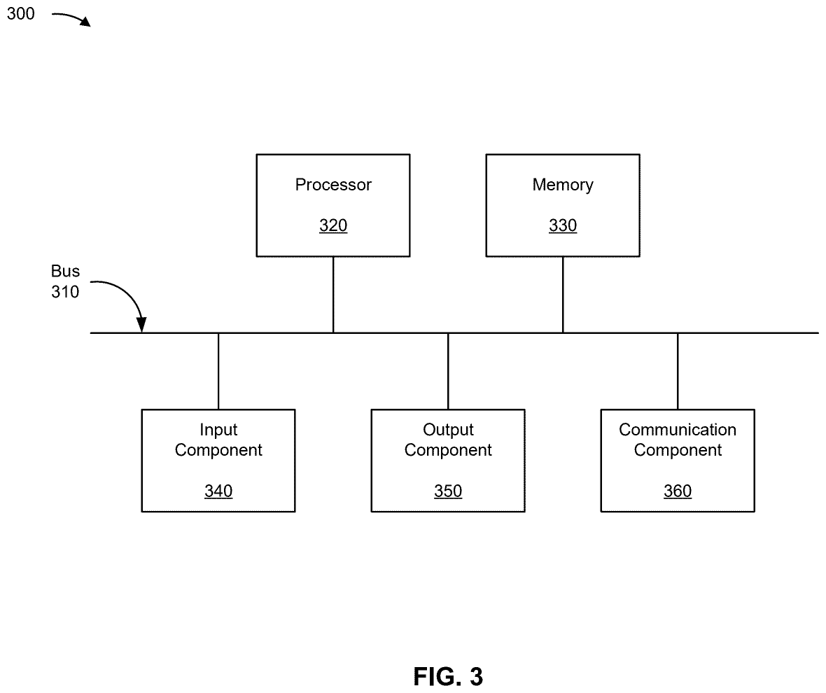

FIGS. 1A-1C are diagrams of an example 100 associated with data generation for artificial intelligence model training. As shown in FIGS. 1A-1C, example 100 includes a client device 102 and a server device 104. These devices are described in more detail in connection with FIGS. 2 and 3.

As further shown in FIG. 1A, and by reference number 150, the server device 104 may receive a request for testing of a new software element. For example, the server device 104 may receive, from the client device 102, a request to test a functionality of the software element. Additionally, or alternatively, the server device 104 may receive, from the client device 102, a request to train an artificial intelligence model or machine learning model associated with a software element. For example, the server device 104 may receive a request to train an artificial intelligence model for fraud detection using financial data, for treatment evaluation using medical data, for process control using sensor data, or for network optimization using network data, among other examples.

As further shown in FIG. 1A, and by reference number 152, the server device 104 may obtain a first data set. For example, the server device 104 may access a restricted data environment 106 to obtain the first data set. A restricted data environment may include one or more computing resources that store a data set that is subject to one or more restrictions. For example, the restricted data environment 106 may include a data structure storing health data, financial data, intellectual property, or transactional data, among other examples. In some implementations, the restricted data environment 106 may include one or more components with a secure storage element. For example, the restricted data environment 106 may include a data structure with one or more encryption protocols implemented to protected data therein.

In some implementations, the server device 104 may provide authentication information to obtain the first data set. For example, the server device 104 may transmit authentication credentials (e.g., user identification information), and the restricted data environment 106 may verify the authentication credentials and may provide the first data set in connection with verifying the authentication credentials. In some implementations, the server device 104 may use a secure communications protocol to obtain the first data set. For example, the server device 104 may establish a secure communications session or tunnel for communications with the restricted data environment 106 and may receive the first data set via the secure communications session. Additionally, or alternatively, the restricted data environment 106 may encrypt the first data set using an encryption protocol and transmit the encrypted first data set to the server device 104, which may decrypt the first data set.

In some implementations, the server device 104 may perform one or more data mining techniques to generate the first data set. For example, the server device 104 may include a transaction processing system and may log a set of transactions that are performed using the server device 104, thereby generating the first data set from logs of the set of transactions. Additionally, or alternatively, the server device 104 may query a group of different restricted data environments 106 and receive responses that the server device 104 may collect into the first data set. In other words, the server device 104 may receive first data from a first data source and second data from a second data source and may merge the first data and the second data to form the first data set. In this case, the server device 104 may perform one or more data merging operations to analyze, correlate, clean, and/or correct the first data and the second data to generate the first data set.

As shown in FIG. 1B, and by reference number 154, the server device 104 may transmit an instruction to a set of data processors 108, which may be components of the server device 104 or a cloud computing system associated therewith, to generate artificial data. For example, the server device 104 may cause the set of data processors 108 to generate a second data set of artificial data using the first data set as an input.

As further shown in FIG. 1B, and by reference number 156, the data processors 108 may generate artificial data using a statistical technique or a generative adversarial network (GAN). In some implementations, the server device 104 may cause the data processors 108 to generate the second data set using one or more statistical techniques. For example, the set of data processors 108 may generate a first set of statistical metrics associated with the first data set using the values of the first data set. The first set of statistical metrics may include variable-level statistical moments and distributions associated with the values of the first data set.

The set of data processors 108 may generate a second set of statistical metrics using the first set of statistical metrics and the first data set. For example, the second set of statistical metrics may include an estimate or determination of a copula (e.g., a multivariate cumulative distribution function) between two distributions (e.g., distributions of the first set of statistical metrics and the first data set). In some implementations, the set of data processors 108 may generate a set of embeddings using the second set of statistical metrics. For example, the set of data processors 108 may embed the second set of statistical metrics in a neural network. In some implementations, the set of data processors 108 may generate noise. For example, the set of data processors 108 may configure a functional architecture or training method of the neural network to introduce a level of noise into data of the neural network, thereby enabling improved anonymization.

The set of data processors 108 may generate a set of values representing the second data set using the embeddings of the neural network (e.g., a GAN). For example, the set of data processors 108 may generate a set of values that have a statistical correlation to values of the first data set but which are synthetic (e.g., artificial), thereby preserving information privacy of the data in the first data set. In some implementations, the set of data processors 108 may use a set of neural network training techniques to generate the set of embeddings. Based on generating the set of values, the server device 104 can expose the synthetic values of the second data set, which is not subject to a usage restriction, without exposing the first data set, which is subject to a usage restriction.

In some implementations, the set of data processors 108 may extrapolate the set of values beyond a range of values of the first data set. For example, when the first data set includes, for a variable, a vector of values in a range of 10-20, the set of data processors 108 may control variation of the neural network to generate values in a vector with a range of 5-25. In this way, the set of data processors 108 generates a set of edge cases or test cases (e.g., statistically outlying data values) for use in testing the software element, while retaining a covariance matrix with correlated variables. Accordingly, by generating the set of edge cases or test cases, the set of data processors 108 enables more robust testing of the software element.

In other words, the set of data processors 108 may use a GAN to produce data records of values of the second data set. Accordingly, the set of data processors 108 may reproduce a covariance matrix representing the first data set, statistically, by generating synthetic data that is meaningfully distinct and that offers coverage beyond a range of the first data set. In this case, for a given first data set of size N×K rows and columns, the GAN may produce any arbitrary quantity of data entries, such that correlations between the K columns and the N rows are preserved and such that there is variance between field values of the arbitrary quantity of data entries.

As shown in FIG. 1C, and by reference number 158, the server device 104 may receive composite artificial data and/or embeddings. For example, the server device 104 may receive the second data set, which may be a composite artificial data set generated using the GAN, or may receive the embeddings of the GAN (e.g., which may enable the server device 104 to operate the GAN to generate the composite artificial data set). In some implementations, the server device 104 may receive the second data set or the GAN from the set of data processors 108, which may be components of a system architecture for generating testing data. For example, as described in more detail with regard to FIG. 2, a system may include the server device 104 and a set of computing resources corresponding to the data processors 108-1 through 108-N. In this case, the set of computing resources may be arranged to efficiently generate, update, and transmit the second data set, as described in more detail herein.

As further shown in FIG. 1C, and by reference number 160, the server device 104 may test the software element using the artificial data and/or the embeddings. For example, the server device 104 may use the second data set to evaluate the software element. In some implementations, the server device 104 may execute a set of tests of the software element using the second data set. For example, the server device 104 may provide values from the second data set into the software element to test functionality of the software element (e.g., determine whether there are errors generated and/or caused by code of the software element). Additionally, or alternatively, the server device 104 may train a machine learning model or artificial intelligence model of the software element using the second data set as inputs, and may evaluate an accuracy of the machine learning model or the artificial intelligence model.

As further shown in FIG. 1C, and by reference number 162, the server device 104 may transmit response information as a response to the request to test the software element. For example, the server device 104 may transmit information indicating a result of operating a set of tests using the second data set. Additionally, or alternatively, the server device 104 may transmit information identifying a set of predictions or determinations from a machine learning model or artificial intelligence model trained using the second data set. In some implementations, the server device 104 may expose the second data set. For example, the server device 104 may store the second data set in a database and may expose the database (e.g., via an application programming interface (API)) or may transmit the second data set to the client device 102 directly. In this case, the client device 102 may use the second data set without violating a usage restriction that is associated with the first data set. In some implementations, the server device 104 may provide a subset of the second data set. For example, the server device 104 may output the set of edge cases (e.g., the statistically outlying values) to enable the client device 102 to evaluate performance of the software element in connection with possible edge cases that can occur.

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a client device 210, a server device 220, and a network 230. Devices of environment 200 may interconnect via wired connections, wireless connections, or a combination of wired and wireless connections.

The client device 210 may include one or more devices capable of receiving, generating, storing, processing, and/or providing information associated with generating artificial data, as described elsewhere herein. The client device 210 may include a communication device and/or a computing device. For example, the client device 210 may include a computing device, a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The server device 220 may include one or more devices capable of receiving, generating, storing, processing, providing, and/or routing information associated with artificial data generation, as described elsewhere herein. The server device 220 may include a communication device and/or a computing device. For example, the server device 220 may include a server, such as an application server, a client server, a web server, a database server, a host server, a proxy server, a virtual server (e.g., executing on computing hardware), or a server in a cloud computing system. In some implementations, the server device 220 may include computing hardware used in a cloud computing environment.

As shown in FIG. 2, the server device 220 may include a system with an architecture of resources and/or components to enable efficient deployment of generative artificial intelligence (AI) models in testing environments. For example, a server device 220 may include one or more synthetic resource groups, each of which include a persistent storage array with a set of storage units. The server devices 220 may implement one or more protocols for persisting data or copies of data across synthetic resource groups to provide redundancy and/or efficient storage or recall. In this case, by transmitting information to other server devices 220, the server device 220 enables data to be stored in data structures of the other server devices 220, which can expose the data via protocol functions, such as an API function. The server device 220 may implement a storage interface that may provide access to the persistent storage array to a primary control and/or a secondary controller. The primary controller and/or the secondary controller may communicate with client devices 210 via one or more networks 230, such as a local area network (LAN) and/or a storage area network (SAN).

In some implementations, the server device 220 may use a controller to receive and route data to one or more machine learning models operating on one or more server devices 220. For example, the server device 220 may receive data for a machine learning model and route the data to graphical processing unit (GPU) resources (or other processing resources) of the server device 220 or another server device 220 for processing. The server device 220 may use the GPU resources (or other processing resources) to generate artificial data derived from the received data. The server device 220 may transmit the artificial data and/or metadata associated therewith (e.g., derived from the received data) to a continuous training facility. A continuous training facility may include one or more resources operating on the server device 220 to train and use a machine learning model. The received data and/or the generated artificial data can be stored, mirrored (e.g., to other server devices 220), and/or transmitted to other synthetic resource groups via transmission protocols. For example, when the controller determines that another synthetic resource group is not being used to generate data, the controller may route the received data to the other synthetic resource group for artificial data generation, thereby achieving load balancing.

The network 230 may include one or more wired and/or wireless networks. For example, the network 230 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a LAN, a SAN, a near-field communication network, a telephone network, a private network, the Internet, and/or a combination of these or other types of networks. The network 230 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with data generation for artificial intelligence model training. The device 300 may correspond to client device 210 and/or server device 220. In some implementations, client device 210 and/or server device 220 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

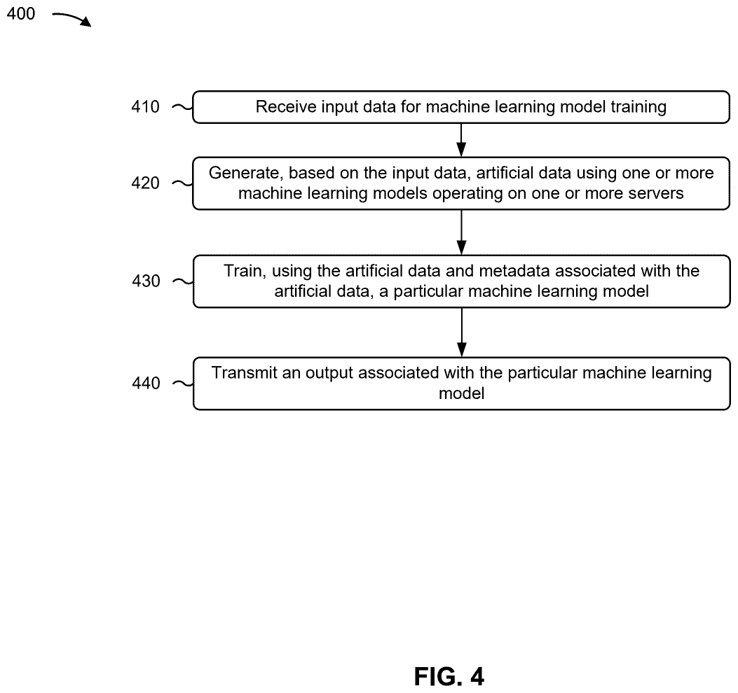

FIG. 4 is a flowchart of an example process 400 associated with data generation for artificial intelligence model training. In some implementations, one or more process blocks of FIG. 4 may be performed by the server device 220. In some implementations, one or more process blocks of FIG. 4 may be performed by another device or a group of devices separate from or including the server device 220, such as the client device 210. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving input data for machine learning model training (block 410). For example, the server device 220 (e.g., using processor 320, memory 330, input component 340, and/or communication component 360) may receive input data for machine learning model training, as described above in connection with reference number 152 of FIG. 1A. As an example, the server device 220 may receive a first data set of protected healthcare data.

As further shown in FIG. 4, process 400 may include generating, based on the input data, artificial data using one or more machine learning models operating on one or more servers, wherein the one or more machine learning models includes a generative artificial intelligence model configured to generate the artificial data such that the artificial data shares a set of common characteristics with the input data (block 420). For example, the server device 220 (e.g., using processor 320 and/or memory 330) may generate, based on the input data, artificial data using one or more machine learning models operating on one or more servers, wherein the one or more machine learning models includes a generative artificial intelligence model configured to generate the artificial data such that the artificial data shares a set of common characteristics with the input data, as described above in connection with reference number 156 of FIG. 1B. As an example, the server device 220 may generate artificial healthcare data, that maintains statistical correlations of the protected healthcare data, without being specific to actual people and subject to a data protection restriction. In some implementations, the one or more machine learning models includes a generative artificial intelligence model configured to generate the artificial data such that the artificial data shares a set of common characteristics with the input data.

As further shown in FIG. 4, process 400 may include training, using the artificial data and metadata associated with the artificial data, a particular machine learning model (block 430). For example, the server device 220 (e.g., using processor 320 and/or memory 330) may train, using the artificial data and metadata associated with the artificial data, a particular machine learning model, as described above in connection with reference number 160 of FIG. 1C. As an example, the server device 220 may train a machine learning model for patient diagnosis based on the artificial healthcare data.

As further shown in FIG. 4, process 400 may include transmitting an output associated with the particular machine learning model (block 440). For example, the server device 220 (e.g., using processor 320, memory 330, and/or communication component 360) may transmit an output associated with the particular machine learning model, as described above in connection with reference number 162 of FIG. 1C. As an example, the server device 220 may deploy the patient diagnosis model and/or a prediction performed using the patient diagnosis model.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for synthetic data generation, the system comprising:
one or more memories; and
one or more processors, communicatively coupled to the one or more memories, configured to:
receive a first data set,
wherein the first data set is subject to a usage restriction;
generate a first set of statistical metrics associated with the first data set based on values of the first data set;
generate a second set of statistical metrics associated with the first set of statistical metrics and the values of the first data set,
wherein the first set of statistical metrics and the second set of statistical metrics comprise a second data set that is not subject to the usage restriction,
wherein the second set of statistical metrics represents a set of correlations between the values of the first data set and the first set of statistical metrics;
generate a set of embeddings with artificial noise based on the second data set; and
output information associated with the set of embeddings.

2. The system of claim 1, wherein the one or more processors are further configured to:
generate a set of edge cases associated with the set of embeddings,
wherein the set of edge cases represent one or more statistically outlying values based on the second set of statistical metrics; and
wherein the one or more processors, to output the information associated with the set of embeddings, are configured to:
output information identifying the set of edge cases.

3. The system of claim 1, wherein the one or more processors, to generate the set of embeddings, are configured to:
train a machine learning model using the second data set; and
execute a set of test cases on the machine learning model based on training the machine learning model; and
wherein, the one or more processors, to output information associated with the set of embeddings, are configured to:
output information associated with the machine learning model.

4. The system of claim 1, wherein the one or more processors are further configured to:
generate, using the second data set, a set of values using a generative adversarial network, the set of values having a correlation to the values of the first data set; and
wherein the one or more processors, to generate the set of embeddings, are configured to:
generate the set of embeddings based on the set of values generated using the generative adversarial network.

5. The system of claim 1, wherein the first set of statistical metrics includes a set of statistical moments relating to the values of the first data set.

6. The system of claim 1, wherein the first set of statistical metrics includes one or more distributions relating to the values of the first data set.

7. The system of claim 1, wherein the second set of statistical metrics includes a copula between the values of the first data set and the first set of statistical metrics.

8. The system of claim 1, wherein the one or more processors, when configured to generate the set of embeddings, are configured to:
generate the set of embeddings using a neural network training technique.

9. A method of generating testing data using a generative artificial intelligence model, comprising:
receiving, by a device, input data for machine learning model training;
generating, by the device and based on the input data, artificial data using one or more machine learning models operating on one or more servers,
wherein the one or more machine learning models includes a generative artificial intelligence model configured to generate the artificial data such that the artificial data shares a set of common characteristics with the input data;
training, by the device and using the artificial data and metadata associated with the artificial data, a particular machine learning model; and
transmitting, by the device, an output associated with the particular machine learning model.

10. The method of claim 9, further comprising:
generating a set of copies of the input data; and
wherein generating the artificial data using the one or more machine learning models operating on the one or more servers comprises:
transmitting the set of copies of the input data to the set of servers,
wherein a server, of the set of servers, implements a machine learning model of the one or more machine learning models; and
receiving, as a response to transmitting the set of copies of the input data, a set of portions of the artificial data.

11. The method of claim 9, further comprising:
storing a set of copies of the artificial data at the one or more servers; and
exposing the set of copies of the artificial data stored at the one or more servers via one or more protocol functions.

12. The method of claim 9, wherein transmitting the output associated with the particular machine learning model comprises:
transmitting a prediction associated with the machine learning model.

13. The method of claim 9, wherein transmitting an output associated with the particular machine learning model comprises:
transmitting information for storage in a data structure of a synthetic resource group, the synthetic resource group being configured to persist data of the data structure across one or more other synthetic resource groups.

14. A non-transitory computer-readable medium storing a set of instructions, the set of instructions comprising:
one or more instructions that, when executed by one or more processors of a system, cause the system to:
receive a first data set,
wherein the first data set is subject to a usage restriction;
generate a first set of statistical metrics associated with the first data set based on values of the first data set;
generate a second set of statistical metrics associated with the first set of statistical metrics and the values of the first data set,
wherein the first set of statistical metrics and the second set of statistical metrics comprise a second data set that is not subject to the usage restriction, and
wherein the second data set includes artificial data and metadata for the artificial data,
wherein the second set of statistical metrics represents a set of correlations between the values of the first data set and the first set of statistical metrics;
generate a set of embeddings with artificial noise based on the second data set; and
output information associated with the set of embeddings.

15. The non-transitory computer-readable medium of claim 14, wherein the one or more instructions further cause the system to:
generate a set of edge cases associated with the set of embeddings,
wherein the set of edge cases represent one or more statistically outlying values based on the second set of statistical metrics; and
wherein the one or more instructions, that cause the system to configure to output the information associated with the set of embeddings, cause the system to:
output information identifying the set of edge cases.

16. The non-transitory computer-readable medium of claim 14, wherein the one or more instructions, that cause the system to configure to generate the set of embeddings, cause the system to:
train a machine learning model using the second data set; and
execute a set of test cases on the machine learning model based on training the machine learning model; and
wherein the one or more instructions, that cause the system to output information associated with the set of embeddings, cause the system to:
output information associated with the machine learning model.

17. The non-transitory computer-readable medium of claim 14, wherein the one or more instructions further cause the system to:
generate, using the second data set, a set of values using a generative adversarial network,
wherein the set of values have a correlation to the values of the first data set; and
wherein the one or more instructions, that cause the system to generate the set of embeddings, cause the system to:
generate the set of embeddings based on the set of values generated using the generative adversarial network.

18. The non-transitory computer-readable medium of claim 14, wherein the first set of statistical metrics includes a set of statistical moments relating to the values of the first data set.

19. The non-transitory computer-readable medium of claim 14, wherein the first set of statistical metrics includes one or more distributions relating to the values of the first data set.

20. The non-transitory computer-readable medium of claim 14, wherein the second set of statistical metrics includes a copula between the values of the first data set and the first set of statistical metrics.
